(19) United States
(12) Patent Application Publication
(10) Pub. No.: US 2004/0198883 A1
(43) Pub. Date: Oct. 7, 2004

(54) Biphasic dispersing compositions for oil products

(76) Inventors: Francesco Crescenzi, Rome (IT); Filippo Porcelli, Rome (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/483,091

(22) PCT Filed: Jul. 9, 2002
(86) PCT No.: PCT/EP02/07637

(30) Foreign Application Priority Data
Jul. 13, 2001 (IT) MI2001A001496

(51) Int. Cl. C08L 1/00

(52) U.S. Cl. 524/315; 524/318; 524/484

(57) ABSTRACT

A description follows of biphasic dispersing compositions comprising a hydrophilic surfactant insoluble in oil and an organic carrier miscible with oil. The biphasic compositions are useful in the treatment of accidental oil spills in the sea.

The present invention relates to biphasic dispersing compositions of oil products in water comprising a hydrophilic surfactant insoluble in oil and an organic solvent miscible with oil.

A method which is generally adopted for accidents causing oil spills in the sea comprises treatment of the oil stains with a dispersant in order to form stable emulsions of oil in sea water.

The dispersing agent is distributed on the oil stains by means of a series of sprayers usually transported by ships or aeroplanes.

Oil-soluble dispersants have the specific characteristic of being particularly suitable for this use as they easily enter into contact with the oil stains and give rise to the formation of emulsions without any particular difficulty.

In order to ensure that this occurs, during the mixing of the two phases, it is necessary, in fact for the surfactant to migrate onto the water/oil interface which has just been formed, in order to stabilize it before the coalescence mechanisms destroy it. This migration is clearly favoured by the oil-solubility of the dispersant.

For these reasons, oleophilic dispersants are commonly used in the case of accidents which cause crude-oil spills in the sea (D. S. Etkin, Oil Spill Dispersants: from technology to policy. Cutter Information Ed. 1999).

A dispersant which is soluble in water and insoluble in oil, on the other hand, often proves to be ineffective for this treatment.

Once applied, in fact, it is rapidly distributed in the mass of water and as the water/oil ratio is normally enormous, it rapidly dissolves in the water causing the loss of a part of the product and compromising the success of the application.

This explains why the use of some biodispersants soluble in water and insoluble in oil has so far been limited to particular applications such as the transportation of heavy crude-oils (M. E. Hayes, E. Nestaas, K. R. Hrebenar; Microbial Surfactants. Chemtech April 1986, pages 239-243).

Dispersants of this type however can have the advantage of not only having a valid dispersing capacity but also good environmental compatibility and easy biodegradability. This is the case, for example, of the EPS biopolymer produced by a micro-organism and described in patent EP 924221.

The possibility of their being used would therefore allow the consequences of accidents causing oil spills in the sea, to be faced in an environmentally acceptable way.

It has now been found that biphasic compositions comprising hydrophilic surfactants insoluble in oil and suitable carriers can be effectively used as oil dispersants in water.

The object of the present invention therefore relates to biphasic dispersing compositions comprising a hydrophilic surfactant insoluble in oil or in organic solvents and an organic carrier freely miscible with oil.

The biphasic compositions according to the invention can be applied to oil spills with the usual dispersant distribution systems and guarantee the rapid penetration of the surfactant into the oil to be treated.

The biphasic compositions according to the invention also allow some hydrophilic surfactants to be used as dispersants, which are obtained in solid form and whose direct use on oil would be particularly ineffective.

Surfactants which can be used for the preparation of the biphasic compositions of the invention are hydrophilic surfactants insoluble in organic solvents; biosurfactants insoluble in organic solvents such as the EPS biopolymer produced by the micro-organism Acinetobacter Calcoaceticus described in patent EP 924221, are preferably used.

Examples of organic solvents miscible with oil which can be used for the preparation of the biphasic compositions of the invention are ecocompatible and biodegradable organic solvents such as paraffinic mineral oils and esters of fatty acids of a natural origin. Methyl oleate, limonene, biodiesel, white mineral oils are preferably used.

The content of surfactant in the compositions ranges from 5% to 50% by weight, preferably from 30% to SOt.

The surfactant is generally present in solid form and in small granules.

It has been observed that biphasic compositions with granule sizes of less than 5 microns have a better dispersing capacity.

The biphasic compositions are prepared by mixing the surfactant with the organic solvent and then grinding the mixture in a mill until the desired granule size is obtained.

The following examples demonstrate the significant improvement in the dispersing efficacy obtained with the biphasic compositions of the inventions.

The efficacy is also evaluated in relation to the granule size of the surfactant.

The experimental data refer both to the biphasic compositions comprising hydrophilic biosurfactants known for their dispersing capacity of oil in water, such as the EPS biopolymer produced by the micro-organism Acinetobacter Calcoaceticus ER 96 (CBS Nr. 962.97) and surfactine, a biosurfactant produced by Bacillus Subtilis (Cooper, D. G. MacDonald, C. R., Duff, S. J. B. and Kosaric, N (1981) Appl. Environ. Microbiol. 42, 408-412), and also to a synthesis hydrophilic surfactant (Sodium Dodecyl Sulfate) which does not have a great dispersing efficacy but is evaluated to demonstrate the applicative generality of the solution found.

The dispersion tests were carried out using a standard evaluation method often adopted for identifying the applicability of dispersing products for oil spills.

The method used is the Rotating Flask Test (Labofina/Warren Spring Laboratory). The description of the test is provided for example in: J. R. Clayton, Jr., J. R. Payne and J. S. Farlow, Oil Spill Dispersants Mechanisms of Action and Laboratory Tests, pages 63-65. D. K. Smoley Ed. 1993.

### EXAMPLE 1

5 ml of Crude-oil, from which the most volatile part has been removed by distillation at 150° C., and 200 mg of the products to be tested, are deposited in a separating funnel containing 250 ml of seawater. After 1 minute, the mixture is stirred for 2 minutes at 33 revs/min. and after another minute 50 ml of water containing the dispersed crude-oil is removed from the bottom. The dispersed oil contained in the water sample is extracted with dichloromethane and spectroscopically measured at 580 nm. Table 1 shows the dispersing efficiency for the four products and that of an oil sample not treated with the dispersant:

1. EPS surfactant used in aqueous solution

2. EPS surfactant used as a fine suspension in the organic carrier methyl oleate

3. EPS surfactant used as a fine suspension in the organic carrier limonene

4. Methyl oleate

5. Limonene

6. Sample not treated with dispersant

TABLE 1
Dispersing efficiency measured for EPS surfactant

| | Percentage of |
|---|---|
| Product | dispersed oil |
| 1 | 5 |
| 2 | 35 |
| 3 | 36 |
| 4 | 3 |
| 5 | 3 |
| 6 | 2.5 |

The results clearly demonstrate the inefficiency of the dispersant used in aqueous solution whose dispersing capacity is equal to that obtained without a dispersant or with solvent alone and the distinct improvement in efficacy obtained using the surfactant in suspension. The equivalence between the data corresponding to the suspensions with the two organic solvents: methyl oleate and limonene shows that the increase in efficacy is due to the use of surfactant in fine powder form and that the only function of the organic solvent is to convey the surfactant inside the oil mass.

### EXAMPLE 2

5 ml of Crude-oil, from which the most volatile part has been removed by distillation at 150° C., and 200 mg of the products to be tested, are deposited in a separating funnel containing 250 ml of seawater. After 1 minute, the mixture is stirred for 2 minutes at 33 revs/min. and after another minute 50 ml of water containing the dispersed crude-oil is removed from the bottom. The dispersed oil contained in the water sample is extracted with dichloromethane and spectroscopically measured at 580 nm. Table 2 shows the dispersing efficiency for the five products tested and that of an oil sample not treated with the dispersant:

1. Surfactine surfactant used in aqueous solution

2. Surfactine surfactant used as a fine suspension in the organic carrier methyl oleate

3. Surfactine surfactant used as a fine suspension in the organic carrier limonene

4. Methyl oleate

5. Limonene

6. Sample not treated with dispersant

TABLE 2
Dispersing efficiency measured for Surfactine surfactant

| | Percentage of |
|---|---|
| Product | dispersed oil |
| 1 | 5 |
| 2 | 31 |
| 3 | 33 |
| 4 | 3 |
| 5 | 3 |
| 6 | 2.5 |

The results clearly demonstrate the inefficiency of surfactine dispersant used in aqueous solution, whose dispersing capacity is equal to that obtained without a dispersant or with solvent alone and the distinct improvement in efficacy obtained using the surfactant in suspension. The equivalence between the data corresponding to the suspensions with the two organic solvents: methyl oleate and limonene shows that the increase in efficacy is due to the use of surfactant in fine powder form and that the only function of the organic solvent is to convey the surfactant inside the oil mass.

### EXAMPLE 3

5 ml of Crude-oil, from which the most volatile part has been removed by distillation at 150° C., and 200 mg of the products to be tested, are deposited in a separating funnel containing 250 ml of seawater. After 1 minute, the mixture is stirred for 2 minutes at 33 revs/min. and after another minute 50 ml of water containing the dispersed crude-oil is removed from the bottom. The dispersed oil contained in the water sample is extracted with dichloromethane and spectroscopically measured at 580 nm. Table 3 shows the dispersing efficiency for the five products tested and that of an oil sample not treated with the dispersant:

1. Sodium dodecyl sulfate surfactant used in aqueous solution

2. Sodium dodecyl sulfate surfactant used as a fine suspension in the organic carrier methyl oleate

3. Sodium dodecyl sulfate surfactant used as a fine suspension in the organic carrier limonene

4. Methyl oleate

5. Limonene

6. Sample not treated with dispersant

TABLE 3
Dispersing efficiency measured for Sodium dodecyl
sulfate surfactant

| | Percentage of |
|---|---|
| Product | dispersed oil |
| 1 | 15 |
| 2 | 25 |
| 3 | 25 |
| 4 | 3 |
| 5 | 3 |
| 6 | 2.5 |

The results clearly demonstrate the distinct improvement in efficacy obtained using the surfactant in suspension. The equivalence between the data corresponding to the suspensions with the two organic solvents: methyl oleate and limonene shows that the increase in efficacy is due to the use of surfactant in fine powder form and that the only function of the organic solvent is to convey the surfactant inside the oil mass.

### EXAMPLE 4

5 ml of Crude-oil, from which the most volatile part has been removed by distillation at 150° C., and 200 mg of the products to be tested, are deposited in a separating funnel containing 250 ml of seawater. After 1 minute, the mixture is stirred for 2 minutes at 33 revs/min. and after another minute 50 ml of water containing the dispersed crude-oil is removed from the bottom. The dispersed oil contained in the water sample is extracted with dichloromethane and spectroscopically measured at 580 nm. Table 4 shows the dispersing efficiency for the two products examined:

1. EPS surfactant used in the form of an aqueous solution

2. EPS surfactant used as a suspension, ground to an average granule size of less than 5 microns, in the organic carrier limonene.

TABLE 4
Dispersing efficiency measured for EPS surfactant
ground to 5 microns

| | Percentage of |
|---|---|
| Product | dispersed oil |
| 1 | 5 |
| 2 | 41 |

The results clearly demonstrate the distinct improvement in efficacy obtained using the surfactant in suspension ground to obtain granules with dimensions of less than 5 microns.

### EXAMPLE 5

5 ml of Crude-oil, from which the most volatile part has been removed by distillation at 150° C., and 200 mg of the products to be tested, are deposited in a separating funnel containing 250 ml of seawater. After 1 minute, the mixture is stirred for 2 minutes at 33 revs/min. and after another minute 50 ml of water containing the dispersed crude-oil is removed from the bottom. The dispersed oil contained in the water sample is extracted with dichloromethane and spectroscopically measured at 580 nm. Table 5 shows the dispersing efficiency for the two products examined:

1. EPS surfactant used in the form of an aqueous solution

2. EPS surfactant used as a suspension, ground to an average granule size of 1.5 microns, in the organic carrier limonene.

TABLE 5
Dispersing efficiency measured for EPS surfactant
ground to 1.5 microns

| | Percentage of |
|---|---|
| Product | dispersed oil |
| 1 | 5 |
| 2 | 51 |

The results clearly demonstrate the distinct improvement in efficacy obtained using the surfactant in suspension ground to 1.5 microns with respect to that in aqueous solution and to the more grossly ground suspension described in Example 4.

1. Biphasic dispersing compositions comprising a hydrophilic surfactant insoluble in oil or in organic solvents and an organic carrier miscible with oil, characterised in that the surfactant is present in the form of microgranules having dimensions of less than 5 microns, in concentrations ranging from 5 to 50% by weight.

2. The biphasic dispersing compositions according to claim 1, wherein the surfactant is selected from EPS biopolymer product by the microorganism Acinetobacter Calcoaceticus, sodium dodecyl sulphate, and surfactine.

3. The biphasic dispersing compositions according to claim 1, wherein the organic carrier miscible with oil is selected from the group consisting of: paraffinic mineral oils, esters of fatty acids of a natural origin and natural hydrocarbons.

4. The biphasic dispersing composition according to claim 3, wherein the organic carrier miscible with oil is selected from methyl oleate, biodiesel, limonene and white mineral oils.

5. The biphasic dispersing compositions according to claim 1, wherein the surfactant is present in concentrations ranging from 30 to 50% by weight.

6. A method for the preparation of biphasic dispersing compositions according to claim 1, which consists in mixing the surfactant with the organic carrier and subsequently grinding the mixture in a mill until the desired granule-size is obtained.

7. A method for dispersing oil products in the sea which consists in treating oil spills with the biphasic compositions according to claim 1.

8. Use of the biphasic compositions according to claim 1, as dispersants of oil substances in water.
